(19) United States
(12) Patent Application Publication
(10) Pub. No.: US 2026/0067113 A1
(43) Pub. Date: Mar. 5, 2026

(54) PROACTIVE QUERIES FOR PERSONAL VIRTUAL ASSISTANTS

(71) Applicant: Microsoft Technology Licensing, LLC, Redmond, WA (US)

(72) Inventors: Lars BRENNA, Tromsø (NO); Paul Meyer LEVLIN, Tromsø (NO)

(21) Appl. No.: 18/826,160

(22) Filed: Sep. 5, 2024

(51) Int. Cl. H04L 12/18; G06N 3/0455; G06N 3/092

(52) U.S. Cl. CPC H04L 12/1818; G06N 3/0455; G06N 3/092; H04L 12/1831

(57) ABSTRACT

Systems and methods for generating virtual assistant proactive queries improving virtual assistant-user interaction. Initial user prompts, including trigger conditions, corresponding to one or more initial user sessions are received. The initial user prompts, and trigger conditions, are stored in a query log database. Pattern recognition is performed on the stored initial user prompts, and the corresponding trigger conditions, to determine a proactive prompt for a subsequent user session. A proactive response is generated from the proactive prompt. Prior to receiving a subsequent user prompt, the proactive response is provided during the subsequent user session upon detection of one or more trigger conditions corresponding to the proactive prompt.

### BACKGROUND

A Virtual Assistant (VA) is a tool that can help users perform various tasks using, among other techniques, a Large Language Model (LLM) to interpret a user's natural language input. A user can communicate with the VA via a chat-based platform that integrates numerous services and applications. The VA could then, for example, help a user plan a meeting, send emails, create documents, search for information, and so forth.

### SUMMARY

The disclosed examples are described in detail below with reference to the accompanying drawing figures listed below. The following summary is provided to illustrate some examples disclosed herein. This Summary is not intended to identify key features or essential features of the claimed subject matter, nor is it intended to be used as an aid in determining the scope of the claimed subject matter.

Solutions are disclosed herein which improve the predictive capabilities of the VA and improve user experience by improving the underlying capability and functionality of the VA to provide proactive and adaptable results more relevant to a user's needs. In one example, a method of generating virtual assistant proactive queries is disclosed. The method includes receiving initial user prompts of a user corresponding to one or more initial user sessions and providing the initial user prompts as inputs to a Large Language Model (LLM) during one or more initial user sessions. The initial user prompts, and one or more trigger conditions corresponding to the initial user prompts are stored in a query log database. Pattern recognition is performed on the stored user prompts, and the one or more trigger conditions, to determine a proactive prompt for a subsequent user session. A proactive response is generated from the proactive prompt. One or more of the trigger conditions corresponding to the proactive prompt are detected prior to receiving a subsequent user prompt during the subsequent user session, and the proactive response is provided during the subsequent user session in response to the detection.

### BRIEF DESCRIPTION OF THE DRAWINGS

FIG. 1 is a diagram illustrating an artificial neural network.

FIG. 2 is a diagram illustrating a transformer network.

FIG. 3 is a diagram illustrating a proactive LLM.

FIG. 4 is a flowchart for a method for proactive user queries.

FIG. 5 is a diagram illustrating a communications sequence.

FIG. 6 is a diagram illustrating a communications sequence.

FIG. 7 is a functional block diagram of a computing apparatus.

Corresponding reference characters indicate corresponding parts throughout the drawings. Any of the figures may be combined into a single example or embodiment.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

A challenge with VAs is that a user must express their needs explicitly and reactively every time the user needs assistance. This can be time-consuming, impractical, and frustrating for the user, especially when the user has repeated or predictable needs, which could be automated. For example, a user who often has meetings with different people may need to ask the VA for relevant information regarding the meeting participants, agenda, previous communications between the participants, etc. This can be a repetitive and tedious process for the user which diminishes their experience with the VA.

Currently, predicting a user's next request is challenging for VAs due to several factors. The dynamic nature of a user's natural language prompts, and the lack of continuous feedback loops, make refining LLM predictions difficult. Contextual ambiguity and limited historical memory make it hard to accurately gauge a user's intent, especially when the user's natural language prompt is vague, or the user engages in abrupt topic changes. LLMs also struggle with sequential dependencies and surface-level understanding, which hinder the LLM's ability to grasp nuanced requests. Additionally, dataset limitations and biases can skew the LLMs predictions by missing less common user behaviors.

Aspects of this disclosure address the aforementioned problem in an unconventional manner to enhance the predictive capabilities of the VA and improve user experience by improving the underlying capability and functionality of the VA to provide proactive and adaptable results more relevant to a user's needs. More specifically, aspects of this disclosure relate to a system and method for improving the functionality of a VA by analyzing a user's query log history to identify patterns in the stored natural language prompts and corresponding contextual and/or semantic information, and then predicting, based on the pattern recognition and corresponding contextual data, a future query or prompt and proactively executing the predicted prompt prior to a subsequent user interaction or event to proactively provide results to a user prior to receiving any user prompts in the subsequent interaction or event, thereby improving the user-computer interaction with the VA.

By predicting a prompt or query, proactively executing the predicted prompt or query, and storing the resulting response to the proactively executed prompt, the underlying VA significantly decreases the number of input prompts that are required from the user to execute the underlying task, e.g., gathering information in preparation for a meeting, initiating a meeting, sending an email, generating a document, summarizing emails or documents, search and retrieval of information, etc. In this sense, these techniques materially improve the performance of generative AI within the context of a VAs by reducing the amount of human interaction needed to execute the task, or produce a result, while also improving convergence time (e.g., how quickly meetings are prepared for, or initiated, emails are sent, emails or documents are created or summarized, information is retrieved, and so forth) and providing a more seamless user experience-all of which are key performance indicators (KPIs) for generative AI within the context of VAs, prior to a user's specific input prompt, thereby improving the user experience.

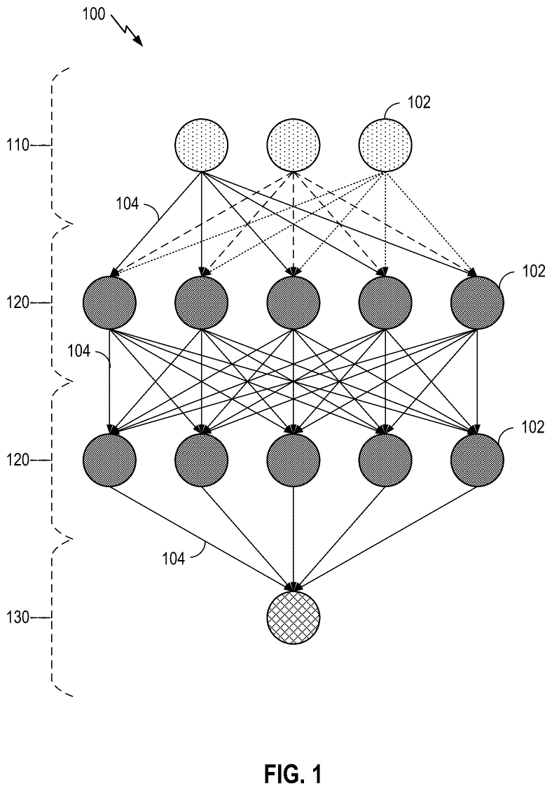

FIG. 1 is a diagram illustrating an artificial neural network (ANN) 100. Typically, an ANN is organized into layers with each layer performing a different transformation of its received input signals. A typical layer organization may include an input layer 110, one or more hidden layers 120, and an output layer 130. As shown in FIG. 1, ANN 100 includes four layers, an input layer 110, two hidden layers 120, and an output layer 130.

Each layer of ANN 100 consists of connected nodes 102 which are interconnected by edges 104. In ANN 100, input layer 110 includes three nodes 102, each hidden layer 120 includes five nodes 102, and the output layer 130 includes one node. The three nodes 102 of input layer 110 are each connected to each of the five nodes of the first hidden layer 120 by edges 104. Each of the five nodes 102 in the first hidden layer 120 are connected by edges 104 to each of the five nodes 102 of the second hidden layer 120. Each of the five nodes 102 in the second hidden layer 120 are connected to the single node 102 of the output layer 130.

Each node 102 of ANN 100 receives input signals, typically made of real numbers, from one or more connected nodes 102 via one or more edges 104. The node 102 then processes the received input signal using a transformation function and transmits result as an output signal to one or more connected nodes 102 via one or more edges 104. The strength of the signal at each connection is determined by a weight which is adjusted during a training process. Training an ANN traditionally involves inputting labeled training data to the ANN to iteratively update the parameters of the ANN, such as edge 104 weights, to minimize some defined loss function.

ANNs, such as ANN 100, come in a variety of “types” including, but not limited to, feedforward (e.g., group method, autoencoder, probabilistic, time delay, convolutional, deep stacking, tensor, tensor deep stacking), radial basis function, general regression, deep belief, recurrent (e.g., fully recurrent, Hopfield, Boltzmann, self-organizing, learning vector, simple recurrent), reservoir computing, echo state, bidirectional, stochastic, genetic scale, modular (e.g., associative, machine committee), physical (e.g., ADALINE memristor, and optical), dynamic (e.g., cascading, neuro-fuzzy, compositional pattern-producing), memory-based (e.g., one-shot associative, hierarchical temporal, holographic associative, long short-term memory), encoder-decoder, decoder only, instantancously trained, spiking, spatial, neo-cognition, compound hierarchical-deep, deep predictive coding, multilayer kernel, transformers, and others.

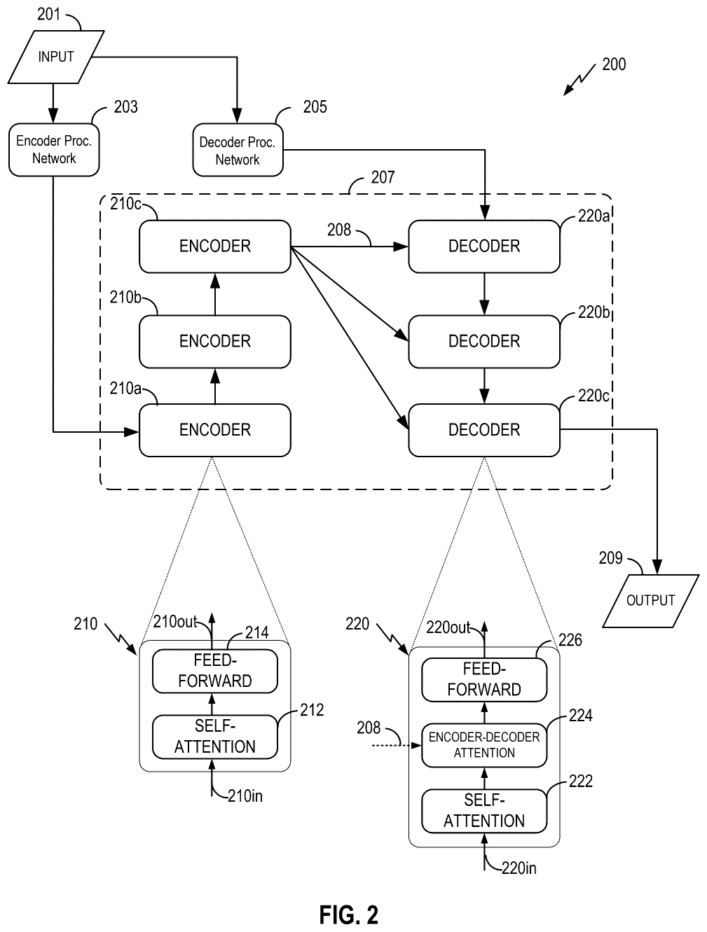

FIG. 2 is a diagram illustrating a diagram of a transformer network 200 according to one or more embodiments described herein. Transformer networks, such as transformer network 200, are a type of neural network architecture primarily used in natural language processing models, such as the Large Language Models (LLMs) described below. Transformer networks offer some advantages over other neural network architectures, such as the ability to process the entire data input, e.g., a natural language prompt (NLP), all at once rather than piecemeal. A transformer network, such as the transformer network 200 shown in FIG. 2 includes at least a transformer network input 201, an encoder processing network 203, a decoder processing network 205, an encoder-decoder stack 207 including one or more encoders 210 and one or more decoders 220, and a transformer network output 209 layer.

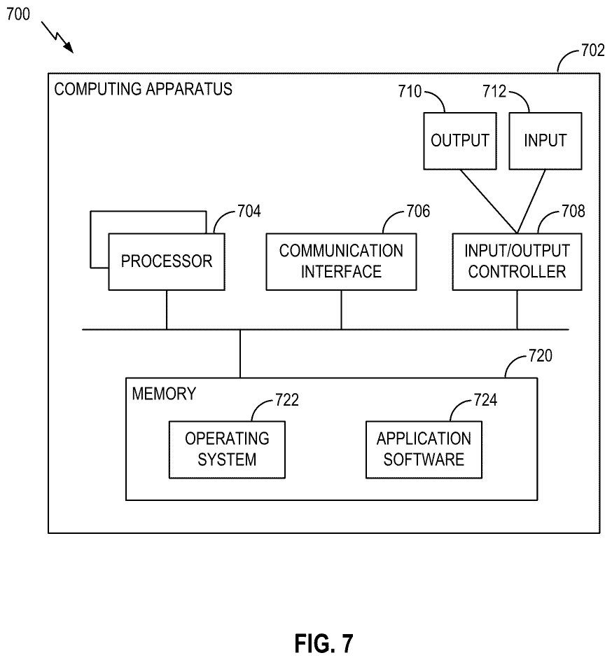

Transformer network 200 includes transformer network input 201. Transformer network input 201 is connected to the encoder processing network 203 and the decoder processing network 205. The transformer network input 201 is configured to accept an input prompt. The input prompt may be a natural language prompt (NLP) including of a series of words, characters, numbers, symbols, or any combination thereof, from any suitable input device, (e.g., the computing device shown in FIG. 7), and deliver the NLP to the encoder processing network 203 and the decoder processing network 205.

Transformer network 200 includes an encoder processing network 203. Encoder processing network 203 includes one or more embedding layers (not shown) and one or more position encoding layers (not shown). The encoder processing network 203 is configured to accept an input prompt from transformer network input 201, perform work on the input prompt (i.e., input embedding), and output one or more embedded input matrices representing the processed input prompt to the encoder-decoder stack 207.

The one or more embedding layers of the encoder processing network 203 map each input token (e.g., word, sub-word, or character) of the input prompt to a word identifier (ID). The word IDs are next converted into a fixed-size vector. The conversion to a fixed-size encoding vector is achieved through a learned embedding matrix, where each row corresponds to the embedding of a unique token for each word ID in the learned embedding matrix. For example, if the input prompt consists of tokens [t₁, t₂, . . . , tₙ], the one or more embedding layers maps the tokens to encoding vectors [e₁, e₂, . . . , eₙ].

The one or more position encoding layers of the encoder processing network 203 map each input token of the input prompt to one or more position encoding (PE) vectors. The one or more position encoding layers operate independently of the one or more embedding layers. Each position encoding is a fixed value that depends only upon the max length of the input prompt. The position encodings may be computed by using sine and cosine functions,

$${PE}_{( pos , 2 i )} = sin ( \frac{pos}{1000 {0}^{2 i / d} model} ) , and {PE}_{( p o s , 2 i + 1 )} = cos ( \frac{pos}{1000 {0}^{2 i / d} model} ) ,$$

where pos is the position of the token in the input prompt, i is the index value of the position vector, and d_{model} is the length of the encoding vector.

The one or more embedding layers of the encoder processing network 203 lastly add the one or more encoding vectors and one or more position vectors, [e₁+PE₁, e₂+PE₂, . . . , eₙ+PEₙ], to create one or more embedded input matrices (e.g., input embeddings) which are then output the encoder-decoder stack 207.

Transformer network 200 includes a decoder processing network 205. The decoder processing network 205 includes one or more embedding layers (not shown) and one or more position encoding layers (not shown). The decoder processing network 205 is configured to accept an input prompt from transformer network input 201, perform work on the input prompt (i.e., output embedding), and output one or more embedded output matrices representing the processed input prompt to the encoder-decoder stack 207. The decoder processing network 205 operates in a comparable manner to the encoder processing network 203 described above one key difference. Before output embedding, the input prompt has its data shifted one position to the right and has a start token inserted in its first position.

Transformer network 200 includes an encoder-decoder stack 207. The encoder-decoder stack 207 includes one or more encoders 210 and one or more decoders 220. In the transformer network 200 illustrated in FIG. 2, there are three encoders 210, a first encoder 210a, a second encoder 210b, and a third encoder 210c, and three decoders 220, a first decoder 220a, a second decoder 220b, and a third decoder 220c.

The one or more encoders 210 each include an encoder input 210 in and an encoder output 210out. Each encoder input 210 in may be connected to the output of the encoder processing network 203, one or more encoder outputs 210out, or to one or more decoders 220. The one or more decoders 220 each include a decoder input 220 in and a decoder output 220out. Each decoder input 220 in may be connected to one or more encoder outputs 210out, one or more decoder inputs 220 in, one or more decoder outputs 220out, a decoder processing network 205, or the transformer network output 209.

The transformer network 200 shown in FIG. 2 includes three encoders 210, a first encoder 210a, a second encoder 210b, and a third encoder 210c, arranged in a stack (e.g., daisy chain) configuration allowing each successive encoder 210 to build upon the output of the previous encoder 210. Each of the encoders 210 in the transformer network 200 may include multiple layers of interconnected neural networks. Each of the encoders may include skip-connections, normalization layers, or other layers not shown in FIG. 2. Each of the encoders 210 include at least one self-attention network (SAN) 212 and at least one FFN 214, each of which may include multiple layers of interconnected neural networks.

In transformer network 200, the output of the encoder processing network 203 is connected to the encoder input 210 in of the first encoder 210a. The encoder output 210out of the first encoder 210a is connected to the encoder input 210 in of the second encoder 210b. The encoder output 210out of the second encoder 210b is connected to the encoder input 210 in of the third encoder 210c, and the encoder output 210out of the third encoder 210c is connected to each of the decoder inputs 220 in of the one or more decoders 220.

In operation, the encoder input 210 in of the first encoder 210a receives the embedded input matrices from the output of the encoder processing network 203. Internally, SAN 212 of the first encoder 210a accepts the embedded input matrices and generates one or more Context Vectors (CVs). Each of the CVs contains a latent vector representation capturing the different contextual relationships between the sequence and position of the words that originally formed an embedded input matrix. This process of contextualization is commonly referred to as attention, or self-attention.

For each CV, the SAN 212 first transforms the embedded input matrix into three vectors, a Query Vector (QV), a Key Vector (KV), and a Value Vector (VV). Each of the three vectors is computed using learned weight matrices as shown in the equations:

$$QV = {XW}^{Q} , KV = {XW}^{K} , VV = {XW}^{V} ,$$

where X is the input embedding, and W^{Q}, W^{K}, and W^{V}, represent learned value matrices.

Second, an Attention Score (e.g., relevance) is computed. The Attention Scores represent how much focus each position in the embedded input matrix sequence should have on other positions of the sequence. The Attention Score is be computed using the scaled dot product of the QV of one position in the sequence with the KVs of all the positions, followed by a scaling factor via the equation,

$$Attention Score ( Q , K , V ) = softmax ( \frac{Q \cdot {K}^{T}}{\sqrt{{d}_{k}}} ) V ,$$

where Q is the QV for a particular position, K contains the KVs for all positions, V contains the VVs for all positions, and dk is the dimension of the KVs. During the second step, masking is utilized to zero out any padding in the input prompts to ensure that any padding does not contribute to the self-attention process.

In the third step, weighted sums of the VVs are computed. A calculated weighted sum is the Context Vector (CV) for a particular position in the sequence,

$$Context Vector = {\sum }_{i} ( Attention {Score}_{i} \times {VV}_{i} ) ,$$

where VVᵢ is each VV of the VVs weighted by the Attention Score corresponding to its position, Attention Scoreᵢ. To capture the differing aspects of the relationships between the positions of the sequence, multiple sets (e.g., heads) of Q, K, and V matrices and CVs are generated. The CVs of the multiple heads are concatenated and linearly transformed,

$$Multi - Head Output = Concat ( {head}_{1} , {head}_{2} , … , {head}_{h} ) {W}^{0} ,$$

where W⁰ is a learned weight matrix, to create the SAN 212 final output. the SAN 212 final output is subsequently passed to the feed-forward network 214 of the first encoder 210a.

The FFN 214 assists in transforming the SAN 212 final outputs into more useful representations for the modeling task at hand. The feed-forward network (FFN) 214 of the first encoder 210a is applied to each position of the SAN 212 final output independently and identically to generate a FFN 214 final output. The FFN 214 may include one or more neural network layers with a rectified linear unit (ReLU) function in between,

$$FFN ( x ) = max ( 0 , {xW}_{1} + {b}_{1} ) {W}_{2} + {b}_{2} ,$$

where W₁ and W₂ are weight matrices and b₁ and b₂ are bias vectors.

By introducing non-linearity through activation functions such as the ReLU function above, the FFN 214 enables the first encoder 210a, and subsequent encoders of the one or more encoders including the second encoder 210b and the third encoder 210c of the encoder-decoder stack 207 to model more complex patterns and relationships in the input NLP. The FFN 214 final output is connected to the encoder output 210out of the first encoder 210a.

The second encoder 210b accepts the output of the first encoder 210a at its encoder input 210 in as an input. The second encoder 210b processes the input as described above and outputs the result from its encoder output 210out to the encoder input 210 in of the third encoder 210c. The third encoder 210c processes the input as described above and outputs the result from its encoder output each decoder input 220 in of the one or more decoders 220.

The encoder-decoder stack 207 includes one or more decoders 220. In this example, the includes three decoders 220, a first decoder 220a, a second decoder 220b, and a third decoder 220c, arranged in a stack (e.g., daisy chain) configuration. In transformer network 200, the decoder inputs 220 in of the first decoder 220a, the second decoder 220b, and the third decoder 220c, are connected by interconnects 208 to the encoder output 210out of the third encoder 210c. The decoder output 220out of the first decoder 220a is connected to the decoder input 220 in of the second decoder 220b. The decoder output 220out of the second decoder 220b is connected to the decoder input 220 in of the third decoder 220c, and the decoder output 220out of the third decoder 220c is connected to transformer network output 209.

Each decoder 220 may include skip-connections, normalization layers, or other layers not shown in FIG. 2. Each decoder 220 includes at least a self-attention network (SAN) 222, at least an encoder-decoder-attention network (EDAN) 224, and at least a feed-forward network (FFN) 226, each of which (SAN 222, EDAN 224, FFN 226) may include multiple layers of interconnected neural networks.

In operation, the decoder input 220 in of the first decoder 220a receives the embedded target matrices from the output of the decoder processing network 205. Internally, SAN 222 of the first decoder 220a accepts the embedded target matrices and generates one or more Target Context Vectors (TCVs). The SAN 222 operates in a comparable manner as the SAN 212 described above, but operates on a different input, the embedded target matrices, and outputs TCVs to the EDAN 224 of the first decoder 220a.

EDAN 224 of the first decoder 220a operates in a comparable manner as SAN 222 with a key difference. The EDAN 224 receives as input, the output from SAN 222 and the output of the third encoder 210c. The EDAN is therefore getting a representation of the target sequence from the first decoder 220a, SAN 222, and a representation of the input prompt from the output of the third encoder 210c. From this, the EDAN 224 computes attention scores in an analogous manner as described above with the attention scores for each position of the sequence capturing the influence of the attention scores of each position of the input prompt. The output of the EDAN 224 of the first decoder 220a is then passed to the FFN 226 of the first decoder 220a which operates in an analogous manner as FFN 216 described above.

The resulting output of FFN 226 of the first decoder 220a is then transmitted from the decoder output 220out of the first decoder 220a. The second decoder 220b accepts the output of the first decoder 220a at its decoder input 220 in as an input. The second decoder 220b processes the input as described above and outputs the result from its decoder output 220out to the decoder input 220 in of the third decoder 220c. The third decoder 220c processes the input as described above and outputs the result from its decoder output 220out to the transformer network output 209.

The transformer network output 209 of the transformer network 200 receives the result (e.g., one or more context vectors) of the decoder output 220out of the third decoder 220c. The transformer network output 209 is configured to transform its received input into an output sequence. The output sequence may be data, words, characters, numbers, symbols, a natural language text, or any combination thereof, suitable for output to any downstream device. For example, one or more neural networks (e.g., an LLM), a user interface (e.g., the computing device shown in FIG. 10), or any other suitable device or system.

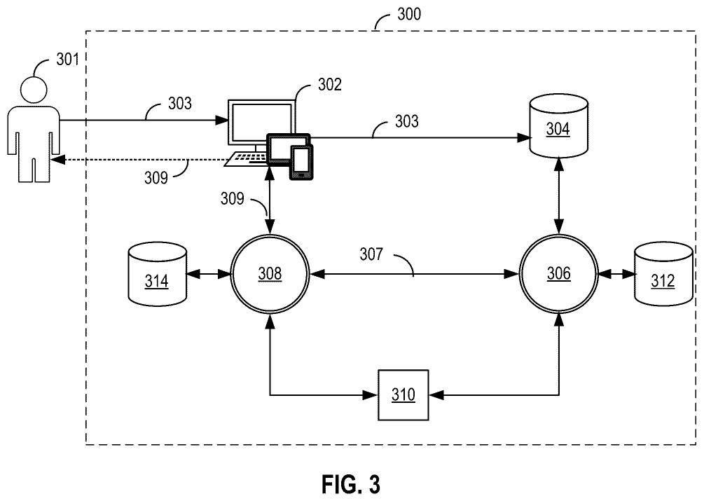

FIG. 3 is a diagram illustrating a proactive virtual assistant (VA) 300. The proactive VA 300 shown in FIG. 3 is an example diagram showing components that are separated by function. The proactive VA 300 includes a user interface (UI) 302, a query log database 304, a pattern recognition service 306, a proactive execution service 308, one or more models 310, proactive prompt database 312, and executed prompt storage 314. In practice, the individual illustrated components may be served by the same component, or combination of components. The proactive VA, as well as the individual illustrated components, may include additional upstream and downstream functions, elements, services, components, and systems. The one or more components of the proactive VA 300 include at least one of a multimodal model (MM), a large language model (LLM), or any other machine learning (ML) or artificial intelligence (AI) model contemplated by the disclosure.

UI 302 is in electrical communication with query log database 304. In some examples, UI 302 may be in electrical communication with one or more other elements, services, components, applications, protocol interfaces, and systems which may be present, but not shown.

UI 302 includes an IO interface. The IO interface of the UI 302 is configured to receive an input prompt 303 for the proactive VA 300. The input prompt 303 may be an initial prompt or subsequent prompt, including a series of words, characters, numbers, symbols, graphics, or any combination thereof, from any suitable input device (e.g., the computing apparatus shown in FIG. 10). In some examples, input prompt 303 is a natural language prompt (NLP). In other examples, input prompt 303 may be a multimodal prompt. Input prompt 303 may be from a user 301, another part of the proactive VM 300, or from an outside system or device, or any combination thereof. Input prompt 303 may be received during an initial user session, during a subsequent user session, or at any time before or after a user session.

The IO interface of the UI 302 is configured to receive an output sequence from the proactive execution service 308. The output sequence received may be a proactive response 309 to the input prompt 303, including a series of words, characters, numbers, symbols, graphics, or any combination thereof suitable to any output device (e.g., the computing apparatus shown in FIG. 10). The proactive response 309 may be presented to the user 301 via UI 302, another part of the proactive VA 300, or to an outside system or device, or any combination thereof. The proactive response 309 may be sent during an initial user session, during a subsequent user session, or at any time before or after a user session.

The proactive VA 300 includes the query log database 304. The query log database 304 is in electrical communication with the UI 302 and the pattern recognition service 306. In some examples, the query log database may be in electrical communication with one or more other elements, services, components, and systems which may be present, but not shown.

In operation, the query log database 304 acts as a database storing and cataloging one or more prompts or queries, such as input prompt 303 received via UI 302. The query log database additionally provides the stored prompts and/or queries to the pattern recognition service 306 or other downstream components of the proactive VA 300. The query log database 304 stores the input prompts in raw or anonymized format for a single user or multiple users on the device originating the input prompt 303, in a centralized database, distributed database, or any combination thereof. During anonymization, the personal identifiable information of the user(s) is either removed, replaced with generic terms, or replaced with variables acting as placeholders, to conceal or obfuscate which user originated the stored prompt. The query log database 304 additionally stores one or more conditions, referred to herein as “trigger conditions,” corresponding to each of the input prompts 303. The trigger conditions may be determined based upon the context/semantic information from the original input prompt 303, previous input prompts, or from external information. The trigger conditions may include dates, times, the presence of a user, user interactions with the VA, user activities with other applications or systems, signaling information from other applications or systems, or other information. For example, a trigger condition may be “every morning at 08:00,” “30 minutes before an event,” “always after a meeting,” or other conditions.

The pattern recognition service 306 is in electrical communication with the query log database 304, one or more models 310, and the proactive execution service 308. In some examples, the pattern recognition service 306 may be in electrical communication with one or more other elements, services, components, and systems which may be present, but not shown.

The pattern recognition service 306 obtains one or more queries or prompts, such as input prompt 303, as well as the one or more trigger conditions associated with each query or prompt, from the query log database 304 and analyzes the received data for patterns associated with contextual and/or other semantic information corresponding to the user associated with the queries or prompts to determine (e.g., predict) one or more proactive prompts 307 for use by the proactive VA 300.

Determining the one or more proactive prompts may include using one or more pattern matching algorithms or machine learning models from one or more models 310. For example, the pattern recognition service 306 may apply federated learning techniques (e.g., a federated pattern recognition service) for pattern recognition of the stored queries and/or prompts, such as input prompt 303, as well as the one or more trigger conditions associated with each query or prompt, using one or more natural language processing models to determine the one or more proactive prompts.

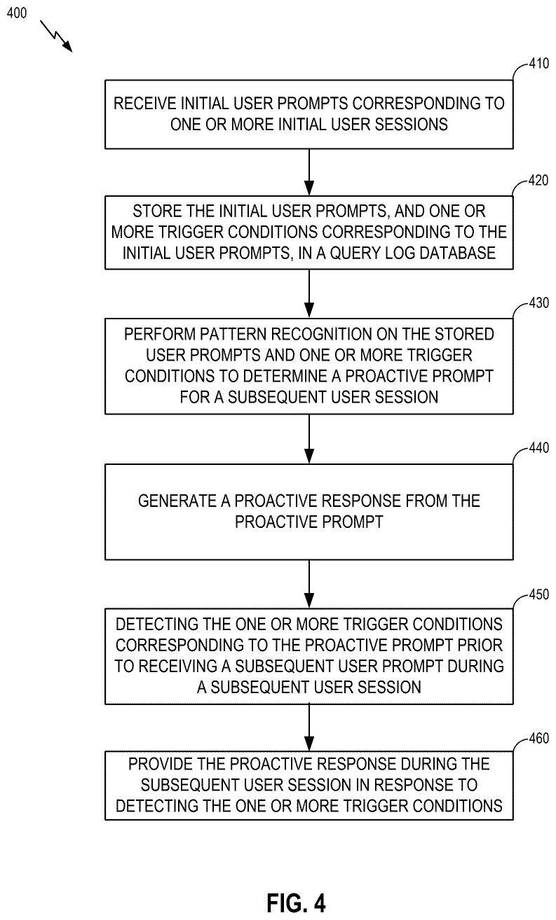

The one or more proactive prompts, along with one or more triggering conditions corresponding to the one or more proactive prompts, may be stored in proactive prompt database 312 for later analysis, retrieval, and/or usage via one or more triggering conditions as described below in FIG. 4. The proactive prompt may be a natural language prompt, a multimodal prompt, or any combination thereof, and may include a series of characters, numbers, symbols, graphics, or any combination thereof.

A federated pattern recognition service uses a global pattern recognition model which is initialized and sent to all participating devices (e.g., proactive VA 300). Each device trains the model using its local data (e.g., its stored queries and/or prompts from query log database 304, such as input prompt 303) using techniques such as tokenization, embedding, and sequence modeling (e.g., using different ANNs such as transformer networks).

The locally trained model parameters (e.g., weights) are sent to the federated pattern recognition service where the federated pattern recognition service aggregates the local model updates to create an updated global pattern recognition model using federated averaging or any other suitable method. The updated global pattern recognition model is then sent back to the participating devices for additional local training. This process allows iterative training until the model converges (achieves satisfactory performance). The final global pattern recognition model is then deployed, and the resulting one or more proactive prompts, and their corresponding triggering conditions, are then made available to the proactive execution service 308.

Proactive execution service 308 may use one or more models 310 to proactively execute one or more proactive prompts stored in proactive prompt database 312 and store the execution results from the one or more models 310 in association with the corresponding proactive prompt utilized, triggering conditions, and other contextual data (e.g., user activities, metadata, signaling from other applications or systems, etc.) in executed prompt storage 314. Proactive VA 300 may subsequently use the stored results in executed prompt storage 314 to dynamically and proactively provide information, task execution, or response generation to a user computing device in a subsequent user session prior to any input or prompt from the user, based on the user context, one or more triggering conditions, signaling information from other applications or systems, or other contextual information identified by the proactive VA. For example, proactive VA 300 subscribes to relevant signals generated by user activity within a computing environment and/or system and reacts when an incoming signal matches a stored trigger, executing the associated proactive prompt to the stored trigger.

FIG. 4 is a flowchart of method 400 for generating virtual assistant proactive queries. Method 400 includes six operations, operation 410, operation 420, operation 430, operation 440, operation 450, and operation 460. The operations of method 400, described below, may be understood with reference to FIGS. 3, and 5-6.

The process begins by receiving the initial prompt 303 of a user 301 corresponding to one or more initial user sessions of the user at operation 410. The initial prompt 303 is provided as input to a model, such as a multimodal model (MM) or Large Language Model (LLM), which is a component of the proactive VA, such as proactive VA 300 in FIG. 3, during the one or more initial user sessions. As described above in FIG. 3, operation 410 includes receiving an initial input prompt 303 corresponding to one or more initial sessions of the user 301 for input into the proactive VA 300.

The initial prompt 303, and one or more trigger conditions corresponding to the initial prompt 303, is stored in query log database 304 at operation 420. Storing the initial prompt 303 and its associated one or more trigger conditions in the query log database 304 is further described above in FIG. 3. The query log database 304 includes one or more queries and/or prompts from a user associated with the proactive VA 300 which may be stored in an anonymized format, and in addition may include one or more queries and/or prompts from other users stored in an anonymized format.

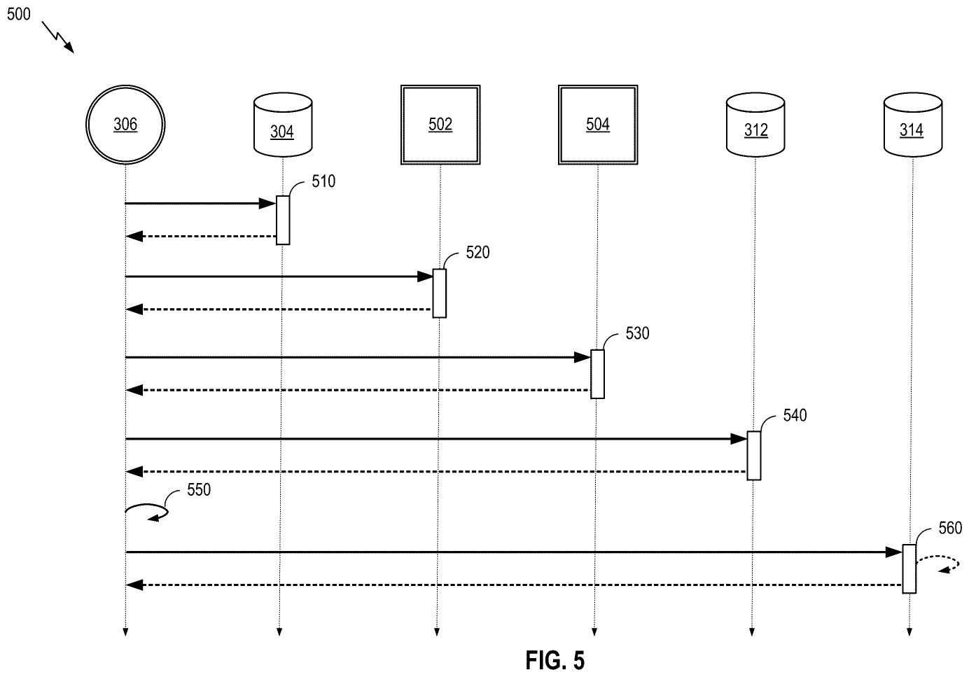

Pattern recognition is performed on the one or more queries and/or prompts, as well as the one or more trigger conditions associated with each query and/or prompt, stored in the query log database 304 by the pattern recognition service 306 to determine one or more proactive prompts for a subsequent user session at operation 430. Operation 430 is further described in more detail in FIG. 5 below.

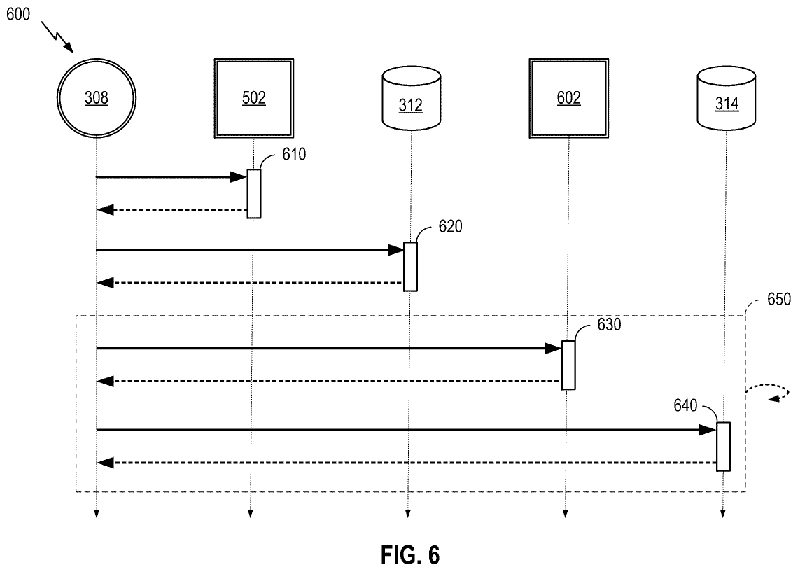

The proactive prompt, such as proactive prompt 307 in FIG. 3, is provided as a machine-generated natural language input to a ML model of the proactive VA, such as a MM or LLM, prior to receiving any input from a user during a subsequent user session to generate a proactive response 309 from the proactive prompt 307 at operation 440 of method 400. Operation 440 of method 400 may be understood with reference to FIG. 6 described below.

A proactive response 309 to the machine-generated natural language input (e.g., proactive prompt 307) is received from the MM or LLM and may be provided to the user during the subsequent user session upon detecting one or more trigger conditions corresponding to the proactive prompt 307.

The proactive execution service 308 of proactive VA 300 detects the one or more trigger conditions corresponding to the proactive prompt 307 prior to receiving a subsequent user prompt during the subsequent user session at operation 450. In some examples, detection of one or more trigger conditions continues during the subsequent user session. Proactive execution service 308 detects trigger conditions by listening to incoming signals, such as signals associated with user activity, and maps the incoming signals to stored triggers associated with proactive prompts. When a signal representing user context matches a stored trigger, the associated proactive prompt 307 is executed and a proactive response 310 is provided to the user. Operation 450 of method 400 may be understood with reference to FIG. 6 below.

The proactive response 309 is provided via the UI 302 to the user 301 during a subsequent user session prior to receiving any input or prompt from the user 301 at operation 460 of method 400. The proactive VA 300 may request, or automatically receive, the proactive response 309 from the proactive execution service 308 corresponding to the current user context/semantic information and triggering conditions. When the proactive VA 300 detects one or more triggering conditions, the proactive VA 300 then outputs the proactive response 309to the user 301 during the subsequent user session. In some examples, the input prompt 303 for the subsequent user session is determined in advance (e.g., predicted) in advance of the subsequent user session.

The operations of method 400 allow for the proactive VA 300 to catalog user prompt 303 in a query log database 304 and use the pattern recognition service 306 to look for context/semantic repetitions, and one or more trigger conditions associated with one or more prompts, in a user's query log database 304, to predict future queries or prompts relevant to the user and/or a specific user context and generate proactive prompts 307 and/or proactive responses 309 for future user sessions. The output of the pattern recognition service 306, the proactive prompts 307, are provided to the proactive execution service 308, which uses one or more models 310, such as MMs or LLMs, to generate an output, such as proactive response 309, for each proactive prompt 307. The proactive execution service 308 then stores each proactive response 309 along with each proactive prompt 307, and corresponding context and/or semantic information for each proactive response 309 in the executed prompt storage 312.

Using the information stored in the executed prompt storage 312, the proactive VA 300 provides the proactive response 309, corresponding to the one or more trigger conditions of the proactive prompt 307 to the user 301 prior to receiving any additional user prompt or input, and faster than conventional methods that require an explicit user prompt for processing.

Further, based upon a user 301 specific query log database 304, or multi-user query log database 304, the proactive VA 300 can proactively provide a predicted proactive response 309 prior to the user 301 providing input or a query, comparable to an output response that would be generated in response to an actual user input or query.

As a non-limiting example, user 301 provides repeated utterances or input, such as input prompt 303, to the proactive VA 300. Repeated utterances may be input such as, “Prep for my meeting,”, “What do I need to know about Aaron A. Aaronson before our meeting,” “send an email to my manager”, “create a presentation for my next meeting” and/or “Help me prepare for my next one on one”, for example. The operations of method 400 store and catalog the input prompt 303 in the query log database 304. The pattern recognition service 306 analyzes the query log database 304 and generates one or more proactive prompts 307 based on, among other things, the context/semantic information of the input prompts. Using the repeated utterances example above, the proactive prompt 307 may be “issue help preparation for meeting instance 10 minutes before meeting instance.” The proactive prompt 307 is processed by the proactive execution service 308 and the result is stored for pro-actively providing to the user 301 prior to the user 301 explicitly requesting meeting preparation information before a next meeting instance. In this example, where a repeated utterance prompts the VA to provide information about meeting invitees/attendees prior to a meeting scheduled on the user's calendar, the proactive VA 300 identifies a next upcoming meeting on the user's calendar and the context associated with the repeated utterance, such as a time period between the user input requesting information on meeting invitees and the next upcoming meeting is received, on average, within one hour of the scheduled meeting. The proactive VA 300 initiates proactive execution service 308 to process a stored proactive prompt for generating meeting prep information, such as the example above, and obtains results associated with the context and semantic information of the next scheduled meeting on the user's calendar in advance of the user requesting assistance with meeting preparation. The proactive VA 300 provides the proactive response 309 via UI 302 to user 301 prior to receiving any user prompt or input, for example, within a threshold time period (e.g., the time period between the user input requesting information on meeting invitees and the next upcoming meeting) or in response to one or more trigger conditions, such as a user interaction with the computing device indicating user presence or other trigger conditions described above (see description of query log database 304).

In some examples, the operations of method 400 include receiving feedback from the user 301 (e.g., a user-feedback) engaging with the computing device during the one or more initial user sessions, or one or more subsequent user sessions, performing reinforcement learning within the proactive VA 300 based upon the user-feedback, and refining the proactive response 309 in advance of the subsequent user session. In some examples, a user interface of a computing device may include interactive features which permit the user 301 to approve or reject the proactive prompts 307 and/or proactive response 309, or for the user to edit a list of possible, or stored, proactive prompts 307, as a user-feedback mechanism.

In some examples, the operations of method 400 include determining that the proactive response 309 has not been used by the user 301 for at least a threshold number of consecutive user sessions following the subsequent user session and deactivating the proactive response 309 in the proactive execution storage 312 based upon the determination. The determination that a proactive response 309 has not been used by the user 301 by any suitable means including, but not limited to, user activity measurements, requiring user actions, or similar techniques employed to detect a user's 301 activity or inactivity.

When the proactive response 309 is deactivated, the proactive VA 300 prevents the deactivated response from being provided to the user 301 prior to a user prompt during subsequent user sessions. In some examples, the operations of method 400 include providing usage-based feedback as output to the proactive VA 300 when a proactive response 309 has been deactivated and using the usage-based feedback for performing reinforcement learning with the one or more models of the proactive VA 300. Deactivated output responses 309, or those receiving negative user-feedback, as well as the corresponding one or more proactive prompts 307, may be retained or discarded dependent upon the configuration of the proactive VA 300. In one example, a storage time threshold may be applied to deactivated output responses, such as a time-to-live count or other timing threshold, so that unused prompts expire and are no longer stored after expiration.

FIG. 5 is a diagram illustrating a communications sequence 500 for performing pattern recognition by the pattern recognition service on the one or more queries or prompts stored in the query log database, such as query log database 304 in FIG. 3. The sequence diagram illustrates six components arranged horizontally, the pattern recognition service 306, the query log database 304, a prompt context service 502, a prompt generalization service 504, a proactive prompt database 312, and an executed prompt storage 314. The communications sequence 500 of FIG. 5 illustrates six steps of operation 430 of method 400. In some examples, operation 430 of method 400 may include more steps, or less steps, than the six steps illustrated in communications sequence 500. For case of description, the six steps illustrated in the communications sequence 500 of FIG. 5 may be divided into two processes, performing pattern recognition, and determining a proactive prompt for the subsequent user session.

The process of performing pattern recognition includes the pattern recognition service 306 requesting one or more query logs from query log database 304 beginning at step 510. Each query log from the query log database 304 includes one or more input prompts, such as input prompt 303 submitted by the user 301 in FIG. 3 for example. The query log provided by the query log database 304 to the pattern recognition service 306 may be from a particular user session, or multiple user sessions. In some examples, the query log provided by the query log database 304 to the pattern recognition service 306 may be from multiple users including user 301. In some examples, the query log provided by the query log database 304 to the pattern recognition service 306 may be in an anonymized format.

The process of performing pattern recognition includes the pattern recognition service 306 requesting contextual and/or semantic (contextual/semantic) information for one or more input prompts stored in the query log database 304 from the prompt context service 502 at step 520. In operation, the prompt context service 502 employs one or more machine learning models, such as one or more models 310 in FIG. 3 for example, to extract contextual/semantic information associated with the requested one or more input prompts and delivers the contextual/semantic information to the pattern recognition service 306. Examples of contextual/semantic information may include the one or more context vectors from a transformation network or LLM as described above in FIG. 2, the one or more trigger conditions described above, or combination thereof. Contextual information provides the parameters for triggering execution of a proactive prompt, that is, the context is the trigger. Signals associated with user activity provide context, in some examples. Pattern recognition service 306 identifies signals that correspond to a trigger for a proactive prompt, for example a trigger may be “every morning” or “before every meeting” or “30 minutes prior to every meeting”, and so forth.

The process of performing pattern recognition includes the pattern recognition service 306 obtaining generalized prompts from the prompt generalization service 504 at step 530. The prompt generalization service 504 generalizes input prompts stored in the query log database to provide generalized prompts that the pattern recognition service uses to discover patterns. For example, stored input prompts such as “when is my next meeting with John Smith”, summarize all emails from John Smith” and “what are my outstanding requests from John Smith” may be generalized by prompt generalization service 504 into a generalized prompt of “help me prepare by gathering emails and tasks before every meeting.”

Determining a proactive prompt for the subsequent user session includes the pattern recognition service 306 using a federated pattern recognition service to generate one or more proactive prompts using the contextual information from prompt context service 502 and the generalized prompts from prompt generalization service 504 and storing the one or more proactive prompts 307 within proactive prompt database 312 at step 540. Proactive prompt database 312 may be a federated prompt storage in some examples.

Determining a proactive prompt for a subsequent user session includes, at step 550, the pattern recognition service 306 repeating step 510, step 520, step 530, and step 540 to continually identify patterns in the stored queries and/or prompts of query log database 304 and create additional proactive prompts for storage in proactive prompt database 312.

Each proactive prompt of the one or more proactive prompts for the subsequent user session may be triggered based on one or more trigger conditions. As discussed above, the trigger conditions may be determined based upon the contextual information received, such as from the context service, incoming signals associated with user activity, calendaring queries for triggers associated with timing parameters, and so forth. For example, a proactive prompt of starting to record a meeting may be triggered when the last invitee is added to the call of a virtual meeting application. This may be determined based on context/semantic information from previous user session(s), such as the user previously and/or repeatedly providing an input of “record” within thirty to sixty seconds of adding the final invitee to a scheduled meeting. Each proactive prompt is associated with its trigger conditions and stored as one or more suggested prompts 307 in the suggested prompt storage at step 560. Following step 540, the pattern recognition service 306 provides the one or more proactive prompts 307 when the corresponding one or more trigger conditions occur from the proactive prompt database 312 to the proactive execution service 308. The execution results (e.g., a proactive response 309) received from proactive execution service 308 are stored, together with the corresponding proactive prompt, in executed prompt storage 314 for later use and deployment by proactive VA 300 in subsequent user sessions.

FIG. 6 is a diagram of a communications sequence 600 illustrating an example of operations 440 and 450 of method 400 as illustrated in FIG. 4. The communications sequence 600 includes five components arranged horizontally, the proactive execution service 308, the prompt context service 502, proactive prompt database 312, a proactive response model 602, and an executed prompt storage 314. The communications sequence 600 of FIG. 6 illustrates five example steps of operations 440 and 450 of method 400. In some examples, there may be more or less steps than those illustrated in communications sequence 600.

The proactive execution service 308 requests and receives the context/semantic information for a user and/or user session from the prompt context service 502 at step 610. The proactive execution service 308 requests and receives one or more proactive prompts 307 corresponding to the user context/semantic information received in step 610 from the proactive prompt database 312 at step 620.

Each proactive prompt 307 is sent to the proactive response model 602 at step 630. The proactive response model 602 may be a component of proactive execution service 308 in FIG. 3, utilizing one or more models 310, for example. In response to each proactive prompt, the proactive response model 602, using one or more ML models, such as MMs or LLMs, returns a proactive response 309 corresponding to the proactive prompt 307.

The proactive execution service 308 then transmits each proactive response 309 in association with the corresponding proactive prompt 307 and its context/semantic information, to the executed prompt storage 314 where the prompt-response sets are stored and cataloged at step 640. Steps 630 and 640 are iteratively repeated for each proactive prompt received at step 650.

The present disclosure is operable with a computing apparatus according to an embodiment as a functional block diagram 700 in FIG. 7. In an example, components of a computing apparatus 702 are implemented as a part of an electronic device according to one or more embodiments described in this specification. The computing apparatus 702 is a computing device, such as, but not limited to, devices that are described in FIGS. 1-6.

The computing apparatus 702 comprises one or more processors 704 which can be microprocessors, controllers, or any other suitable type of processors for processing computer executable instructions to control the operation of the electronic device. Alternatively, or in addition, the processor 704 is any technology capable of executing logic or instructions, such as a hardcoded machine. In some examples, platform software comprising an operating system 722 or any other suitable platform software is provided on the computing apparatus 702 to enable application software 724 to be executed on the device.

In some examples, computer executable instructions are provided using any computer-readable medium or media accessible by the computing apparatus 702. Computer-readable media include, for example, computer storage media such as a memory 720 and communications media. Computer storage media, such as a memory 720, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium does not include a propagating signal. Propagated signals per se are not examples of computer storage media. Although the computer storage medium (the memory 720) is shown within the computing apparatus 702, it will be appreciated by a person skilled in the art, that, in some examples, the storage is distributed or located remotely and accessed via a network or other communication link (e.g., using a communication interface 706).

Further, in some examples, the computing apparatus 702 comprises an input/output controller 708 configured to output information to one or more output devices 710, for example a display or a speaker, which are separate from or integral to the electronic device. Additionally, or alternatively, the input/output controller 708 is configured to receive and process an input from one or more input devices 712, for example, a keyboard, a microphone, or a touchpad. In one example, the output device 710 also acts as the input device. An example of such a device is a touch sensitive display. The input/output controller 708 in other examples outputs data to devices other than the output device, e.g., a locally connected printing device. In some examples, a user provides input to the input device(s) 712 and/or receives output from the output device(s) 710.

The functionality described herein can be performed, at least in part, by one or more hardware logic components. The computing apparatus 702 is configured by the program code when executed by the processor 704 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent can take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all the stated problems or those that have any or all the stated benefits and advantages. It will further be understood that reference to ‘an’ item refers to one or more of those items.

The embodiments illustrated and described herein as well as embodiments not specifically described herein but within the scope of aspects of the claims constitute exemplary means for receiving a first search request, the first search request including one or more search terms; identifying one or more product categories as output from a machine learning classification model in response to inputting of the one or more search terms; identifying a first plurality of products that are assigned to the one or more product categories, each product of the first plurality of products including a plurality of product titles and a plurality of product short descriptions in a natural language; applying the plurality of product titles and the plurality of product short descriptions as input to a second machine learning model that is configured to generate a plurality of recommended searches, each recommended search of the plurality of recommended searches including at least one search term; scoring each recommended search of the plurality of recommended searches; selecting one or more recommended searches of the plurality of recommended searches based on the scoring; and causing the one or more recommended searches to be displayed as user-interactable components on a graphical user interface, each user-interactable component being configured to execute a second search request upon user interaction with the user-interactable component.

At least a portion of the functionality of the various elements in FIG. 1 to FIG. 9 can be performed by other elements in FIG. 1 to FIG. 7, or an entity (e.g., processor, web service, server, application program, computing device, etc.) not shown in FIG. 1 to FIG. 7.

In some examples, the operations described herein can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of assorted examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, In some examples, to a short-range high frequency wireless communication technology for the exchange of data over short distances.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Within the scope of this application, it is expressly intended that the various aspects, embodiments, examples, and alternatives set out in the preceding paragraphs, in the claims and/or in the description and drawings, and particularly the individual features thereof, may be taken independently or in any combination. That is, all embodiments and/or features of any embodiment can be combined in any way and/or combination, unless such features are incompatible. The applicant reserves the right to change any originally filed claim or file any new claim, accordingly, including the right to amend any originally filed claim to depend from and/or incorporate any feature of any other claim although not originally claimed in that manner.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of generating virtual assistant proactive queries, comprising:
receiving initial user prompts of a user corresponding to one or more initial user sessions, wherein the initial user prompts are provided as inputs to a Large Language Model (LLM) during the one or more initial user sessions;
storing the initial user prompts, and one or more trigger conditions corresponding the initial user prompts, in a query log database;
performing pattern recognition on the stored initial user prompts and the one or more trigger conditions to determine a proactive prompt for a subsequent user session;
generating a proactive response from the proactive prompt;
detecting the one or more trigger conditions corresponding to the proactive prompt prior to receiving a subsequent user prompt during the subsequent user session; and
providing the proactive response during the subsequent user session in response to detecting the one or more trigger conditions corresponding to the proactive prompt.

2. The method of claim 1, further comprising detecting the one or more trigger conditions corresponding to the proactive prompt during the subsequent user session.

3. The method of claim 1, wherein the proactive response and corresponding proactive prompt are stored in an executed prompt storage.

4. The method of claim 1, wherein the proactive prompt for the subsequent user session is determined in advance of the subsequent user session.

5. The method of claim 1, further comprising:
receiving a user-feedback during the one or more initial user sessions or one or more subsequent user sessions;
performing reinforcement learning based upon the user-feedback; and
refining the proactive prompt, based upon the user-feedback, prior to the subsequent user session.

6. The method of claim 1, wherein performing pattern recognition on the initial user prompts further comprises performing pattern recognition on one or more user prompts, and the one or more trigger conditions corresponding to the one or more user prompts, from one or more other users that are different than the user associated with the initial user prompts, and wherein the initial user prompts and the one or more user prompts from the one or more other users are stored in the query log database in an anonymized format.

7. The method of claim 1, wherein:
the initial user prompts of the user corresponding to the one or more initial user sessions comprises a request for meeting preparation information before a next meeting instance;
the one or more trigger conditions comprises a threshold time period between the request for meeting preparation information and the next meeting instance;
the proactive prompt comprises a prompt for generating the meeting preparation information corresponding to a next scheduled meeting;
the proactive response corresponding to the proactive prompt comprises the meeting preparation information for the next scheduled meeting; and
providing the proactive response during the subsequent user session in response to detecting the threshold time period before the next scheduled meeting without receiving a subsequent user prompt.

8. The method of claim 1, further comprising:
determining the proactive prompt has not been used by the user for at least a threshold number of consecutive user sessions following the subsequent user session; and
deactivating the proactive prompt based upon the determination, wherein deactivating the proactive prompt prevents the deactivated proactive prompt from being provided prior to a user prompt during subsequent user sessions following the deactivation.

9. A method of generating virtual assistant proactive queries, comprising:
receiving initial user prompts of a user corresponding to one or more initial user sessions of the user, wherein the initial user prompts are provided as inputs to a Large Language Model (LLM) during the one or more initial user sessions;
storing the initial user prompts, and one or more trigger conditions corresponding the initial user prompts, in a query log database;
performing pattern recognition on the stored initial user prompts and the one or more trigger conditions to determine a proactive prompt for a subsequent user session;
generating a proactive response from the proactive prompt;
detecting the one or more trigger conditions corresponding to the proactive prompt prior to receiving a subsequent user prompt during the subsequent user session; and
providing the proactive prompt during the subsequent user session in response to detecting the one or more trigger conditions corresponding to the proactive prompt.

10. The method of claim 9, further comprising:
providing the proactive response during the subsequent user session in response to detecting the one or more trigger conditions corresponding to the proactive prompt.

11. The method of claim 9, further comprising:
receiving a user-feedback during the one or more initial user sessions or one or more subsequent user sessions;
performing reinforcement learning based upon the user-feedback; and
refining the proactive prompt, based upon the user-feedback, prior to the subsequent user session.

12. The method of claim 9, wherein performing pattern recognition on the initial user prompts of the user further comprises performing pattern recognition on one or more user prompts from one or more other users that are different than the user.

13. The method of claim 12, wherein the one or more user prompts from the one or more other users are stored in the query log database in an anonymized format.

14. The method of claim 9, further comprising:
determining the proactive prompt has not been used by the user for at least a threshold number of consecutive user sessions following the subsequent user session; and
deactivating the proactive prompt based upon the determination, wherein deactivating the proactive prompt prevents the deactivated proactive prompt from being provided prior to a user prompt during subsequent user sessions following the deactivation.

15. A system for generating virtual assistant proactive queries, comprising:
a processor;
at least one memory comprising computer-executable instructions for execution by the processor, the computer-executable instructions, upon execution by the processor, causing the processor to:
receive initial user prompts corresponding to one or more initial user sessions, wherein the initial user prompts are provided as inputs to a Large Language Model (LLM) during the one or more initial user sessions;
store the initial user prompts, and one or more trigger conditions corresponding the initial user prompts, in a query log database;
perform pattern recognition on the stored initial user prompts and the one or more trigger conditions to determine a proactive prompt for a subsequent user session;
generate a proactive response from the proactive prompt;
detect the one or more trigger conditions corresponding to the proactive prompt prior to receiving a subsequent user prompt during the subsequent user session; and
provide the proactive response during the subsequent user session in response to detecting the one or more trigger conditions corresponding to the proactive prompt.

16. The system of claim 15, the computer-executable instructions further cause the processor to determine the proactive prompt for the subsequent user session in advance of the subsequent user session.

17. The system of claim 15, the computer-executable instructions further cause the processor to:
providing the proactive response during the subsequent user session in response to detecting the one or more trigger conditions corresponding to the proactive prompt.

18. The system of claim 15, the computer-executable instructions further cause the processor to:
receive a user-feedback during the one or more initial user sessions or one or more subsequent user sessions;
perform reinforcement learning within the LLM, wherein the reinforcement learning is based upon the user-feedback; and
refine the proactive prompt prior to the subsequent user session.

19. The system of claim 15, wherein the computer-executable instructions further cause the processor to store the one or more user prompts, and the one or more trigger conditions corresponding to the one or more user prompts, from one or more other users that are different than the user associated with the initial user prompts, wherein the one or more user prompts from the one or more other users are stored in the query log database in an anonymized format.

20. The system of claim 15, the computer-executable instructions further cause the processor to:
determine the proactive prompt has not been used by the user for at least a threshold number of consecutive user sessions following the subsequent user session; and
deactivate the proactive prompt based upon the determination, wherein deactivating the proactive prompt prevents the deactivated proactive prompt from being provided prior to a user prompt during subsequent user sessions following the deactivation.
